(19) United States
(12) Patent Application Publication
(10) Pub. No.: US 2006/0006792 A1
(43) Pub. Date: Jan. 12, 2006

(54) Flat panel light emitting devices with two sided

(75) Inventor: David R. Strip, Albuquerque, NM (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/888,763

(22) Filed: Jul. 9, 2004

(51) Int. Cl. H01J 1/62

(52) U.S. Cl. 313/500; 313/506

(57) ABSTRACT

A flat panel light emitting device is descried comprised of a transparent substrate, a first organic light emitting diode element disposed over the substrate, a second organic light emitting diode element disposed over the first organic light emitting diode element, and a transparent cover disposed over the second organic light emitting element, wherein each of the first and second light emitting elements comprises an organic light emitting layer positioned between a transparent or semitransparent electrode and a reflective electrode, and wherein the first light emitting element emits light through its transparent or semitransparent electrode and the substrate and the second light emitting element emits light through its transparent or semitransparent electrode and the cover. The flat panel light emitting device is advantageous because it provides the capability to emit independently controlled patterns, colors, and intensities from the two sides of the flat panel.

### FIELD OF THE INVENTION

The present invention relates to the manufacture of flat panel light emitting devices such as displays and extended light sources, an example being organic light emitting diode displays and area illumination sources and, more particularly, to the said devices capable of emitting distinct light patterns and colors on the two faces of the flat panel.

### BACKGROUND OF THE INVENTION

Light emitting flat panel devices are used for a number of applications such as general illumination light sources, decorative light sources, and information displays. U.S. Pat. No. 5,703,436 discloses various embodiments, including an organic light emitting diode (OLED) display (FIG. 17 thereof) that emits light through both sides of the display through use of an electroluminescent material layer between transparent anode and cathode layers. Although enabling two-sided emission, the use of a single emission layer results in substantially the same image being provided on both sides, and the lack of independent control of the images limits the utility. There are many applications in which different patterns of illumination may be desired on opposite sides of a light emitting flat panel device. For example, when the device is a display containing text, unless the reverse side shows a different pattern, the text will appear backwards. In decorative lighting sources, different colors of light and/or different intensities may be desired to light different zones or to create different moods.

U.S. Pat. No. 5,703,436 and JP 06-176870 also each discloses the use of “stacked” structures comprising multiple emitting layers with transparent electrodes therebetween, e.g., in which red, green, and blue OLEDs are stacked one on another to allow a full color to be created. Such stacked embodiments, however, still do not provide for differentiated colors or images to be generated on opposites sides of a flat panel display.

### SUMMARY OF THE INVENTION

In accordance with one embodiment, the present invention is directed towards a flat panel light emitting device comprised of a transparent substrate, a first organic light emitting diode element disposed over the substrate, a second organic light emitting diode element disposed over the first organic light emitting diode element, and a transparent cover disposed over the second organic light emitting element, wherein each of the first and second light emitting elements comprises an organic light emitting layer positioned between a transparent or semitransparent electrode and a reflective electrode, and wherein the first light emitting element emits light through its transparent or semitransparent electrode and the substrate and the second light emitting element emits light through its transparent or semitransparent electrode and the cover. The flat panel light emitting device is advantageous because it provides the capability to emit independently controlled patterns, colors, and intensities from the two sides of the flat panel.

### BRIEF DESCRIPTION OF THE DRAWINGS

FIG. 1 is a is a diagram showing a longitudinal cross section of the OLED component of one embodiment of the invention.

FIG. 2 is a diagram showing a longitudinal cross section of the OLED component of a second embodiment of the invention.

FIG. 3 is a diagram showing a longitudinal cross section of the OLED component of a third embodiment of the invention FIG. 4 is a diagram showing a longitudinal cross section of the OLED component of a fourth embodiment of the invention.

FIG. 5 is a plan view diagram showing an embodiment of the invention utilized as a two-sided passive-matrix display.

FIG. 6 is a detail view of the connections for the device shown in FIG. 5

FIG. 7 is a cross-section of a reflecting electrode layer in accordance with one embodiment of the invention.

### DETAILED DESCRIPTION OF THE INVENTION

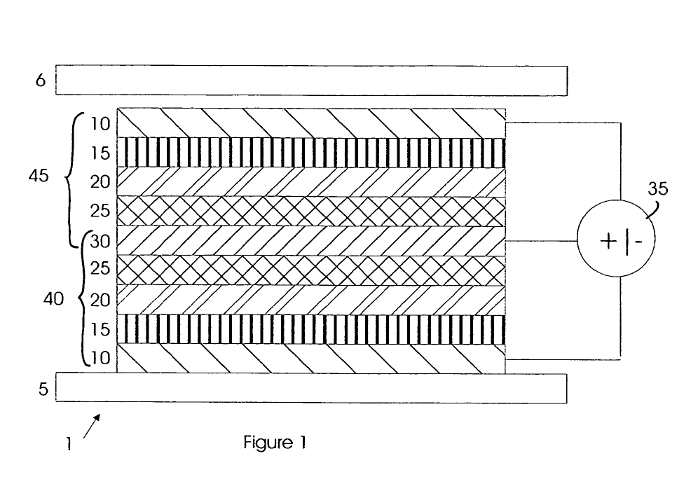

Referring to FIG. 1, a flat panel light emitting device 1 is constructed by depositing two organic light emitting diode (OLED) elements 40 and 45 on a transparent substrate 5 and covering the assembly with a transparent cover 6. In this specific embodiment, light emitting element 40 is constructed by the sequential deposition of thin film layers consisting of a transparent or semitransparent electrode 10 as an anode, a hole injection layer 15, an organic light emitting layer 20, an electron injection layer 25, and a reflective electrode layer 30 as a cathode. The order of layers is then reversed to create light emitting element 45. Electrodes 10 and 30 are connected to power supply 35. It is well-known that the light emitter layer 20 may contain multiple dopants or contain sublayers to control the emission spectrum.

The flat panel light emitting device 1 differs in two significant ways from the devices taught in U.S. Pat. No. 5,703,436 and JP06176870A. In particular, the cathode 30 is a reflecting electrode in contrast to a transparent cathode as taught between the stacked elements in the referenced patents. The use of a transparent cathode results in a device which emits the same color and intensity in both directions. A reflective surface on one side of the device will reflect all light out one side. The use of a reflective electrode between light emitting elements in accordance with the present invention causes each side of the flat panel light emitting device to exhibit independent behavior. A second significant difference is that JP06176870A specifies that the two anodes are electrically tied to one another. This causes the two OLED devices to emit at the same luminance. The invention shown here allows the two anodes to be controlled independently.

Flat panel light emitting devices can be patterned with the anodes and cathodes in the form of orthogonal stripes forming a pattern typically referred to as a passive matrix. This patterning can be applied to the invention as shown in FIG. 1. This patterning can also be applied to the device taught in JP06176870A. In the case of this invention, the resulting flat panel light emitting device has two independently addressable sides, allowing each side to be programmed to present a distinct visual image. In the case of the cited teaching, the device has only a single addressable pattern. For a display showing text, one side of the display will appear backwards.

The electrode 10 may either be a transparent conducting material such as indium-tin-oxide (ITO), or it may be a semitransparent, partially reflective layer made of, e.g., a thin layer of silver, aluminum or other material. In the case of a partially reflecting anode, the devices 40 and 45 may behave as microcavity devices as is known in the art. Microcavity OLED devices comprise an organic light-emitting layer disposed between two reflecting electrodes, each typically having over 30% reflectivity. In most cases, one of the reflecting electrodes is essentially opaque and the other one is semitransparent having an optical density less than 1.0. The two reflecting electrode mirrors form a Fabry-Perot microcavity that strongly affects the emission characteristics of the OLED device. Emission near the wavelength corresponding to the resonance wavelength of the cavity is enhanced and those with other wavelengths are suppressed. The net result is a significant narrowing of the bandwidth of the emitted light and a significant enhancement of its intensity. The emission spectrum is also highly angular dependent, which may be useful for informational and/or decorative purposes. Where microcavity devices are employed as the first and second organic light emitting diode elements, they may advantageously be tuned to different wavelengths by varying the spacing between the two reflecting electrodes to provide different colored light outputs through the substrate and the cover, while employing common light-emitting materials. A light-integrating element as taught in co-pending, commonly assigned U.S. patent application Ser. No. 10/680,758 by Yuan-Sheng Tyan et al., the disclosure of which is incorporated herein by reference, may be employed to broaden the emission spectrum and reduce the angular dependence of light emitted from a microcavity device. A patterned light-integrating element as taught in co-pending, commonly assigned U.S. patent application Ser. No. ______ (Kodak Docket No. 87246) by David R. Strip, the disclosure of which is incorporated herein by reference, may alternatively be employed to maintain the relatively angular+ dependant functionality of the light emitted by a microcavity OLED device in the non-patterned areas, while providing a less angular-dependant light emission in the patterned areas.

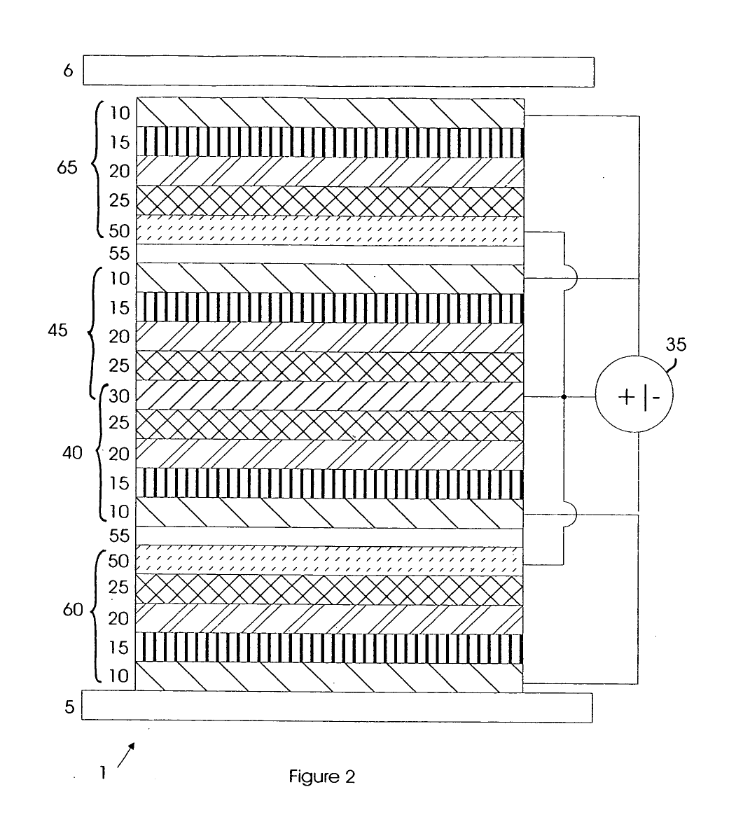

Referring to FIG. 2, a flat panel light emitting device contains 4 distinct OLED light emitting elements, 40, 45, 60, and 65. Each light emitting element is shown as including the well-known stack of anode 10, hole injection layer 15, emitter layer 20, electron injection layer 25, and reflecting cathode 30 or transparent cathode 50. Light emitting elements 40 and 60 and light emitting elements 45 and 65 are separated by a transparent insulating layers 55. In this configuration light emitting elements 40 and 45 may be a common color and light emitting elements 60 and 65 may be a second common color, though any combination of color assignments is possible. Each of the light emitting elements is independently controllable in terms of intensity. The stacking of distinctly colored light emitting elements can be continued to produce three light emitting elements per side, allowing a full-color RGB device. The light emitting elements on either side of the reflecting cathode 30 do not have to have the same number of color choices. For example, one side of reflecting cathode 30 may have a full RGB stack while the other side has a single white light emitting element. As described for FIG. 1, the anodes and cathodes could be patterned to create the familiar passive matrix device.

The invention as shown here differs in two significant aspects from that disclosed in U.S. Pat. No. 5,703,436. In that patent, the OLEDs are stacked as shown for light emitting elements 40 and 60, typically extended to a depth of three for an RGB triad. In U.S. Pat. No. 5,703,436, however, there is no reflecting cathode separating the stacked light emitting elements, but rather a transparent cathode. Such a device emits light on both sides with an identical pattern on each side. The cited patent anticipates the use of an external reflector to bring all the light out one side of the display. Thus, as taught the device is not anticipated to be used in a two-sided configuration and is not independently controllable on the two sides. The present device further differs by containing a second stack of OLED devices on the opposite side of the reflective cathode enabling a distinct image on each side of the device.

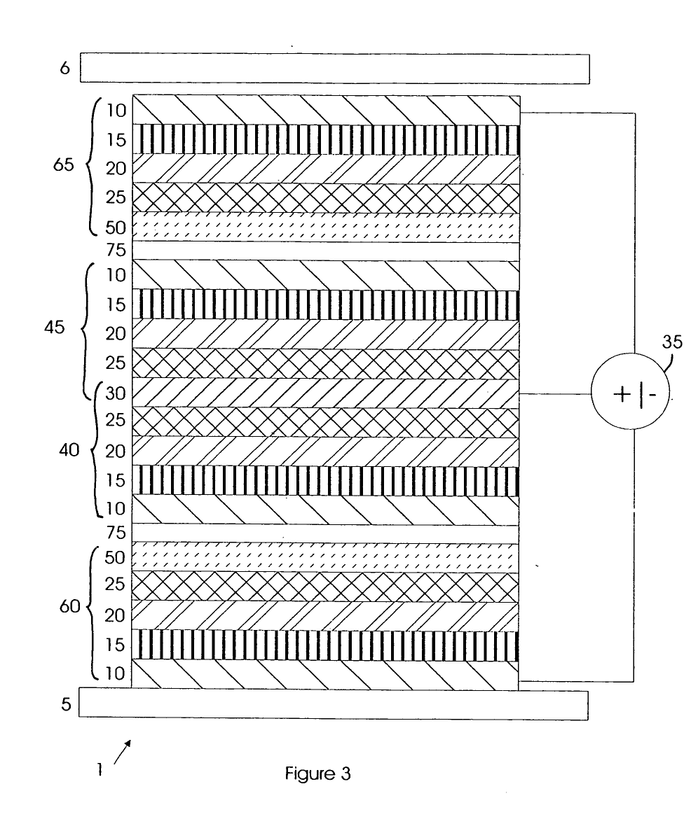

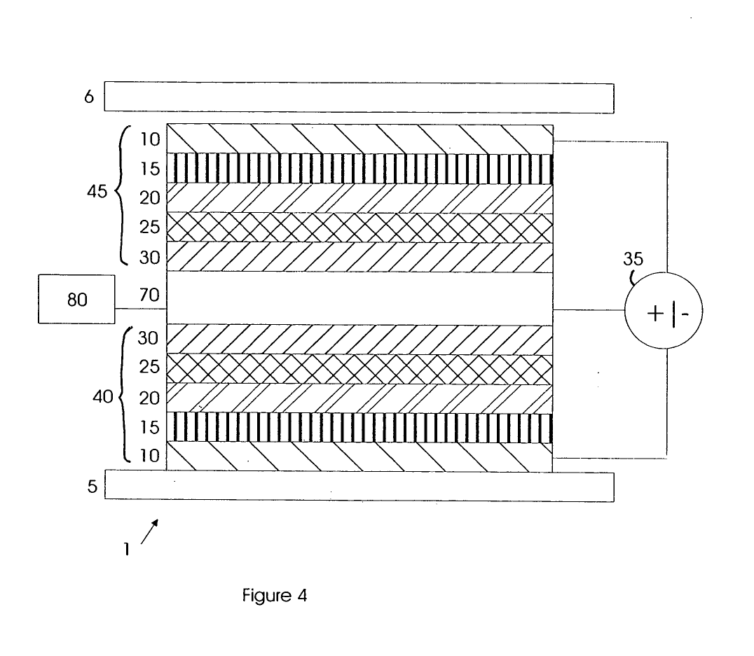

Referring to FIG. 3, the flat panel light emitting device has a configuration known as a stack OLED, also sometimes called a tandem OLED or cascaded OLED. In this configuration, the light emitting elements pair 40 and 60 and pair 45 and 65 are arranged such that current flows in series through the elements of the pair. To create this configuration, the device has a repeating pattern of anode, 10, hole injection 15, emitter layer 20, electron injection layer 25, and transparent cathode 50 or reflective cathode 30, where the repeating units are separating by a connecting layer 75. A number of methods have been demonstrated for fabricating the connecting layer. In some cases the anode and/or the cathode may be functionally incorporated into the connecting layer such that a distinct anode or cathode may not be present. Although shown with two repeating units on each side of the reflecting cathode, it may be anticipated that the flat panel light emitting device could be made with a larger number of repeating units in the stack. It may be further anticipated that the number of repeating units on one side of the reflecting cathode may differ from the number of repeating units on the other side. It may be further anticipated that the color of the emitter in the repeating units may not be the same color in all units and that the pattern and choice of colors on one side of the reflecting cathode may be different from the pattern and choice of colors on the other side of the cathode.

Referring to FIG. 4, the light emitting elements 40 and 45 are separated by a layer of thin-film transistors (TFTs) 70. In general, the TFT layer will contain separate circuits to independently control light emitting element pair 40 and 60 and pair 45 and 65, although it may be anticipated that in some embodiments the pairs may be desired to be controlled simultaneously. The TFT array 70 is controlled via address logic 80 which allows individual light emitting elements in a patterned flat panel light emitting device to be addressed individually, creating the familiar active matrix array.

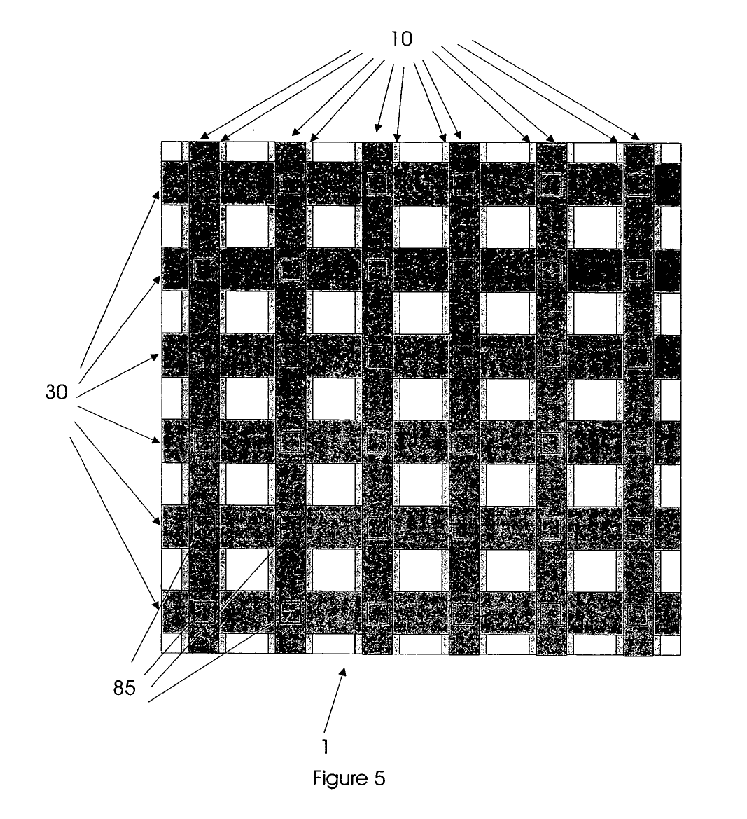

Referring to FIG. 5, the flat panel light emitting device 1 is configured as a two-sided passive matrix device with independent control of the two sides. The anodes 10 form the columns of the device matrix. As illustrated in the diagram and shown in greater clarity in FIG. 1, there are two layers of anodes. In general these actually be the same width, but are shown different widths for clarity. The reflecting cathode layer 30 is also formed of narrow bands of material which are arrayed perpendicular to the anodes 10. The light emitting element stacks 85 are made up of light emitting elements 40 and 45 as shown in FIG. 1 or the repeated stacks shown in FIGS. 2 and 3 and are located at the intersections of the anodes and cathodes. Although the anodes and cathodes are drawn as regular repeating patterns at right angles to one another, it is well understood that many other functionally equivalent patterns exist which may be more appropriate for specific applications, such as iconic style displays.

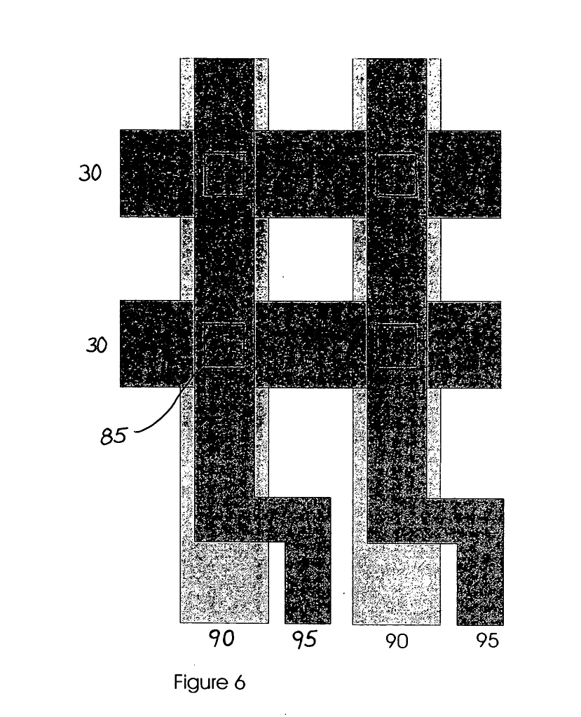

Referring to FIG. 6, a small section of the device 1 in FIG. 5 is shown in greater detail. The diagram illustrates how the upper anode 95 can be configured such that it may lay on the same substrate as the lower anode 90 to simplify interconnection, while maintaining independent control of the light emitting elements in the stack. It is understood by practitioners that an insulating layer must lie between the upper and lower anode. This may be a layer deposited specifically for this purpose. Alternatively, if the two anodes are maintained at a common potential, one or more layers of the OLED device may serve as the insulator.

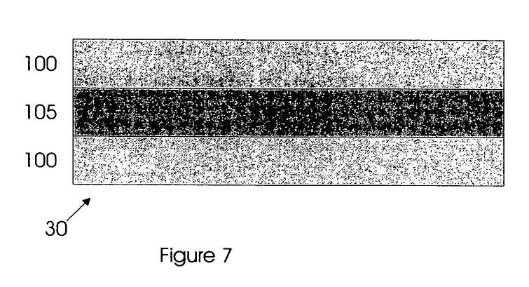

In certain embodiments of the invention it may be desirable for the reflecting electrode to contain additional internal structure. Referring to FIG. 7, a reflecting cathode 30 is shown in greater detail in accordance with a specific embodiment. In particular, the reflecting cathode may contain three layers. The two outer layers 100 are conductive and are separated by an insulating layer 105. The outer layers conveniently may comprise reflective metal layers, though transparent outer electrically conductive layers combined with a reflecting insulating layer would also provide the same functionality. It is understood that the conducting layers may contain further internal structure making them in the same manner as is well-understood in the making of OLED cathodes. By creating a cathode layer with two distinct conducting layers, we provide the opportunity for greater freedom in the control of the two emitting sides of the flat panel device. For example, if each side is patterned to form a passive matrix, a cathode with two independent conducting layers allows the two sides of the passive matrix to be scanned at different rates. Alternatively, the two sides could be patterned with passive matrices of different resolutions. Yet another alternative is to have a passive matrix configuration on one side and an iconic or solid field configuration on the reverse.

In a preferred embodiment, the invention is employed in a device that includes Organic Light Emitting Diodes (OLEDs) which are composed of small molecule or polymeric OLED materials as disclosed in but not limited to commonly-assigned U.S. Pat. No. 4,769,292, issued Sep. 6, 1988 to Tang et al., and U.S. Pat. No. 5,061,569, issued Oct. 29, 1991 to VanSlyke et al. Many combinations and variations of organic light emitting materials can be used to fabricate such a device.

Substrate

The OLED apparatus of this invention is typically provided over a supporting substrate where either the cathode or anode can be in contact with the substrate. The electrode in contact with the substrate is conveniently referred to as the bottom electrode. Conventionally, the bottom electrode is the anode, but this invention is not limited to that configuration. The substrate employed in the present invention is light transmissive to allow for light emission. Transparent glass or plastic is commonly employed in such cases plastic, semiconductor materials, silicon, ceramics, and circuit board materials.

Anode

The anode should be transparent or substantially transparent to the emission of interest. Common transparent anode materials used in this invention are indium-tin oxide (ITO), indium-zinc oxide (IZO) and tin oxide, but other metal oxides can work including, but not limited to, aluminum- or indium-doped zinc oxide, magnesium-indium oxide, and nickel-tungsten oxide. In addition to these oxides, metal nitrides, such as gallium nitride, and metal selenides, such as zinc selenide, and metal sulfides, such as zinc sulfide, can be used as the anode. For applications where a microcavity effect is desired, a partially reflective, semitransparent anode may be employed, e.g., formed from a thin metal layer. Examples for this application include, but are not limited to, gold, iridium, molybdenum, palladium, and platinum. Typical anode materials, transmissive or otherwise, have a work function of 4.1 eV or greater. Desired anode materials are commonly deposited by any suitable means such as evaporation, sputtering, chemical vapor deposition, or electrochemical means. Anodes can be patterned using well-known photolithographic processes or by using shadow masks during preparation.

Hole-Iniecting Layer (HIL)

It is often useful to provide a hole-injecting layer between the anode and the emissive layer. The hole-injecting material can serve to improve the film formation property of subsequent organic layers and to facilitate injection of holes into the hole-transporting layer. Suitable materials for use in the hole-injecting layer include, but are not limited to, porphyrinic compounds as described in commonly assigned U.S. Pat. No. 4,720,432, and plasma-deposited fluorocarbon polymers as described in commonly assigned U.S. Pat. No. 6,208,075. Alternative hole-injecting materials reportedly useful in organic EL devices are described in EP 0 891 121 A1 and EP 1 029 909 A1.

Hole-Transporting Layer (HTL)

The hole-transporting layer contains at least one hole-transporting compound such as an aromatic tertiary amine, where the latter is understood to be a compound containing at least one trivalent nitrogen atom that is bonded only to carbon atoms, at least one of which is a member of an aromatic ring. In one form the aromatic tertiary amine can be an arylamine, such as a monoarylamine, diarylamine, triarylamine, or a polymeric arylamine. Exemplary monomeric triarylamines are illustrated by Klupfel et al. U.S. Pat. No. 3,180,730. Other suitable triarylamines substituted with one or more vinyl radicals and/or comprising at least one active hydrogen containing group are disclosed by Brantley et al in commonly-assigned U.S. Pat. Nos. 3,567,450 and 3,658,520.

A more preferred class of aromatic tertiary amines are those which include at least two aromatic tertiary amine moieties as described in commonly-assigned U.S. Pat. Nos. 4,720,432 and 5,061,569. The hole-transporting layer can be formed of a single or a mixture of aromatic tertiary amine compounds. Illustrative of useful aromatic tertiary amines are the following:
1,1-Bis(4-di-p-tolylaminophenyl)cyclohexane
1,1-Bis(4-di-p-tolylaminophenyl)-4-phenylcyclohexane
4,4′-Bis(diphenylamino)quadriphenyl
Bis(4-dimethylamino-2-methylphenyl)-phenylmethane
N,N,N-Tri(p-tolyl)amine
4-(di-p-tolylamino)-4′-[4(di-p-tolylamino)-styryl]stilbene
N,N,N′,N′-Tetra-p-tolyl-4-4′-diaminobiphenyl
N,N,N′,N′-Tetraphenyl-4,4′-diaminobiphenyl
N,N,N′,N′-tetra-1-naphthyl-4,4′-diaminobiphenyl
N,N,N′,N′-tetra-2-naphthyl-4,4′-diaminobiphenyl
N-Phenylcarbazole
4,4′-Bis[N-(1-naphthyl)-N-phenylamino]biphenyl
4,4′-Bis[N-(1-naphthyl)-N-(2-naphthyl)amino]biphenyl
4,4″-Bis[N-(1-naphthyl)-N-phenylamino]-p-terphenyl
4,4′-Bis[N-(2-naphthyl)-N-phenylamino]biphenyl
4,4′-Bis[N-(3-acenaphthenyl)-N-phenylamino]biphenyl
1,5-Bis[N-(1-naphthyl)-N-phenylamino]naphthalene
4,4′-Bis[N-(9-anthryl)-N-phenylamino]biphenyl
4,4″-Bis[N-(1-anthryl)-N-phenylamino]-p-terphenyl
4,4′-Bis[N-(2-phenanthryl)-N-phenylamino]biphenyl
4,4′-Bis[N-(8-fluoranthenyl)-N-phenylamino]biphenyl
4,4′-Bis[N-(2-pyrenyl)-N-phenylamino]biphenyl
4,4′-Bis[N-(2-naphthacenyl)-N-phenylamino]biphenyl
4,4′-Bis[N-(2-perylenyl)-N-phenylamino]biphenyl
4,4′-Bis[N-(1-coronenyl)-N-phenylamino]biphenyl
2,6-Bis(di-p-tolylamino)naphthalene
2,6-Bis[di-(1-naphthyl)amino]naphthalene
2,6-Bis[N-(1-naphthyl)-N-(2-naphthyl)amino]naphthalene
N,N,N′,N′-Tetra(2-naphthyl)-4,4″-diamino-p-terphenyl
4,4′-Bis {N-phenyl-N-[4-(1-naphthyl)-phenyl]amino}biphenyl
4,4′-Bis[N-phenyl-N-(2-pyrenyl)amino]biphenyl
2,6-Bis[N,N-di(2-naphthyl)amine]fluorene
1,5-Bis[N-(1-naphthyl)-N-phenylamino]naphthalene

Another class of useful hole-transporting materials includes polycyclic aromatic compounds as described in EP 1 009 041. In addition, polymeric hole-transporting materials can be used such as poly(N-vinylcarbazole) (PVK), polythiophenes, polypyrrole, polyaniline, and copolymers such as poly(3,4-ethylenedioxythiophene)/poly(4-styrenesulfonate) also called PEDOT/PSS.

Light-Emitting Layer (LEL)

As more fully described in commonly-assigned U.S. Pat. Nos. 4,769,292 and 5,935,721, the light-emitting layer (LEL) of the organic EL element includes a luminescent or fluorescent material where electroluminescence is produced as a result of electron-hole pair recombination in this region. The light-emitting layer can include a single material, but more commonly consists of a host material doped with a guest compound or compounds where light emission comes primarily from the dopant and can be of any color. The host materials in the light-emitting layer can be an electron-transporting material, as defined below, a hole-transporting material, as defined above, or another material or combination of materials that support hole-electron recombination. The dopant is usually chosen from highly fluorescent dyes, but phosphorescent compounds, e.g., transition metal complexes as described in WO 98/55561, WO 00/18851, WO 00/57676, and WO 00/70655 are also useful. Dopants are typically coated as 0.01 to 10% by weight into the host material. Polymeric materials such as polyfluorenes and polyvinylarylenes (e.g., poly(p-phenylenevinylene), PPV) can also be used as the host material. In this case, small molecule dopants can be molecularly dispersed into the polymeric host, or the dopant could be added by copolymerizing a minor constituent into the host polymer.

An important relationship for choosing a dye as a dopant is a comparison of the bandgap potential which is defined as the energy difference between the highest occupied molecular orbital and the lowest unoccupied molecular orbital of the molecule. For efficient energy transfer from the host to the dopant molecule, a necessary condition is that the band gap of the dopant is smaller than that of the host material.

Host and emitting molecules known to be of use include, but are not limited to, those disclosed in commonly assigned U.S. Pat. Nos. 4,768,292; 5,141,671; 5,150,006; 5,151,629; 5,405,709; 5,484,922; 5,593,788; 5,645,948; 5,683,823; 5,755,999; 5,928,802; 5,935,720; 5,935,721; and 6,020,078.

Metal complexes of 8-hydroxyquinoline (oxine) and similar derivatives constitute one class of useful host compounds capable of supporting electroluminescence. Illustrative of useful chelated oxinoid compounds are the following:
CO-1: Aluminum trisoxine [alias, tris(8-quinolinolato)aluminum(III)]
CO-2: Magnesium bisoxine [alias, bis(8-quinolinolato)magnesium(II)]
CO-3: Bis[benzo {f}-8-quinolinolato]zinc (II)
CO-4: Bis(2-methyl-8-quinolinolato)aluminum(I)-μ-oxo-bis(2-methyl-8-quinolinolato) aluminum(III)
CO-5: Indium trisoxine [alias, tris(8-quinolinolato)indium]
CO-6: Aluminum tris(5-methyloxine) [alias, tris(5-methyl-8-quinolinolato) aluminum(III)]
CO-7: Lithium oxitie [alias, (8-quinolinolato)lithium(I)]
CO-8: Gallium oxine [alias, tris(8-quinolinolato)gallium(III)]
CO-9: Zirconium oxine [alias, tetra(8-quinolinolato)zirconium(IV)]

Other classes of useful host materials include, but are not limited to: derivatives of anthracene, such as 9,10-di-(2-naphthyl)anthracene and derivatives thereof, distyrylarylene derivatives as described in U.S. Pat. No. 5,121,029, and benzazole derivatives, for example, 2,2′,2″-(1,3,5-phenylene)tris[1-phenyl-1H-benzimidazole].

Useful fluorescent dopants include, but are not limited to, derivatives of anthracene, tetracene, xanthene, perylene, rubrene, coumarin, rhodamine, quinacridone, dicyanomethylenepyran compounds, thiopyran compounds, polymethine compounds, pyrilium and thiapyrilium compounds, fluorene derivatives, periflanthene derivatives and carbostyryl compounds.

Electron-Transporting Layer (ETL)

Preferred thin film-forming materials for use in forming the electron-transporting layer of the organic EL elements of this invention are metal chelated oxinoid compounds, including chelates of oxine itself (also commonly referred to as 8-quinolinol or 8-hydroxyquinoline). Such compounds help to inject and transport electrons, exhibit high levels of performance, and are readily fabricated in the form of thin films. Exemplary oxinoid compounds were listed previously.

Other electron-transporting materials include various butadiene derivatives as disclosed in commonly assigned U.S. Pat. No. 4,356,429 and various heterocyclic optical brighteners as described in commonly assigned U.S. Pat. No. 4,539,507. Benzazoles and triazines are also useful electron-transporting materials.

In some instances, the light-emitting layer and electron-transport layers can optionally be collapsed into a single layer that serves the function of supporting both light emission and electron transport. These layers can be collapsed in both small molecule OLED systems and in polymeric OLED systems. For example, in polymeric systems, it is common to employ a hole-transporting layer such as PEDOT-PSS with a polymeric light-emitting layer such as PPV. In this system, PPV serves the function of supporting both light emission and electron transport.

Cathode

When employed as the reflective electrodes, cathodes used in this invention can include nearly any conductive material which is itself reflective, or which is used in combination with an associated reflective layer. Desirable materials have good film-forming properties to ensure good contact with the underlying organic layer, promote electron injection at low voltage, and have good stability. Useful cathode materials often contain a low work function metal (<4.0 eV) or metal alloy. One preferred cathode material is comprised of a Mg:Ag alloy wherein the percentage of silver is in the range of 1 to 20%, as described in commonly assigned U.S. Pat. No. 4,885,221. Another suitable class of cathode materials includes bilayers including a thin electron-injection layer (EIL) in contact with the organic layer (e.g., ETL) which is capped with a thicker layer of a conductive metal. Here, the EIL preferably includes a low work function metal or metal salt, and if so, the thicker capping layer does not need to have a low work function. One such cathode is comprised of a thin layer of LiF followed by a thicker layer of Al as described in commonly assigned U.S. Pat. No. 5,677,572. Other useful cathode material sets include, but are not limited to, those disclosed in commonly assigned U.S. Pat. Nos. 5,059,861; 5,059,862, and 6,140,763.

When light emission is also desired through a cathode, the cathode must be transparent or nearly transparent. For such applications, metals must be thin or one must use transparent conductive oxides, or a combination of these materials. Optically transparent cathodes have been described in more detail in U.S. Pat. Nos. 4,885,211; 5,247,190; 5,703,436; 5,608,287; 5,837,391; 5,677,572; 5,776,622; 5,776,623; 5,714,838; 5,969,474; 5,739,545; 5,981,306; 6,137,223; 6,140,763; 6,172,459; 6,278,236. EP 1 076 368, and JP 3,234,963. Cathode materials are typically deposited by evaporation, sputtering, or chemical vapor deposition. When needed, patterning can be achieved through many well known methods including, but not limited to, through-mask deposition, integral shadow masking as described in commonly assigned U.S. Pat. No. 5,276,380 and EP 0 732 868, laser ablation, and selective chemical vapor deposition.

Deposition of Organic Layers

The organic materials mentioned above are suitably deposited through a vapor-phase method such as sublimation, but can be deposited from a fluid, for example, from a solvent with an optional binder to improve film formation. If the material is a polymer, solvent deposition is useful but other methods can be used, such as sputtering or thermal transfer from a donor sheet. The material to be deposited by sublimation can be vaporized from a sublimator “boat” often comprised of a tantalum material, e.g., as described in commonly-assigned U.S. Pat. No. 6,237,529, or can be first coated onto a donor sheet and then sublimed in closer proximity to the substrate. Layers with a mixture of materials can utilize separate sublimator boats or the materials can be pre-mixed and coated from a single boat or donor sheet. Patterned deposition can be achieved using shadow masks, integral shadow masks (commonly-assigned U.S. Pat. No. 5,294,870), spatially-defined thermal dye transfer from a donor sheet (commonly-assigned U.S. Pat. Nos. 5,851,709 and 6,066,357) and inkjet method (commonly-assigned U.S. Pat. No. 6,066,357).

Encapsulation

Most OLEDs are sensitive to moisture or oxygen, or both, so they are commonly sealed in an inert atmosphere such as nitrogen or argon, along with a desiccant such as alumina, bauxite, calcium sulfate, clays, silica gel, zeolites, alkaline metal oxides, alkaline earth metal oxides, sulfates, or metal halides and perchlorates. Methods for encapsulation and desiccation include, but are not limited to, those described in U.S. Pat. No. 6,226,890. In addition, barrier layers such as SiOx, Teflon, and alternating inorganic/polymeric layers are known in the art for encapsulation.

The invention has been described in detail with particular reference to certain preferred embodiments thereof, but it will be understood that variations and modifications can be effected within the spirit and scope of the invention.

### PARTS LIST

Flat panel light emitting device
5 Substrate
6 Cover
10 Anode
15 Hole injection layer
20 Emitter layer
25 Electron injection layer
30 Reflecting cathode
35 Power supply
40 Light emitting element
45 Light emitting element
50 Transparent cathode
55 Insulating layer
60 Light emitting element
65 Light emitting element
70 TFT layer
75 Connecting layer
80 Address logic
85 Light emitting element stack
90 Lower anode
95 Upper anode
100 Conductive layer
105 Insulating layer

1. A flat panel light emitting device comprised of a transparent substrate, a first organic light emitting diode element disposed over the substrate, a second organic light emitting diode element disposed over the first organic light emitting diode element, and a transparent cover disposed over the second organic light emitting element, wherein each of the first and second light emitting elements comprises an organic light emitting layer positioned between a transparent or semitransparent electrode and a reflective electrode, and wherein the first light emitting element emits light through its transparent or semitransparent electrode and the substrate and the second light emitting element emits light through its transparent or semitransparent electrode and the cover.

2. The flat light emitting device of claim 1 where the device is an area illumination light source.

3. The flat panel light emitting device of claim 2 where the device emits different colored light from each of the substrate and the cover.

4. The light source of claim 2 where each of the first and second light emitting elements are independently controllable.

5. The flat panel light emitting device of claim 1 where the device is a display.

6. The flat panel light emitting device of claim 5 where the device is a passive matrix display.

7. The flat panel light emitting device of claim 5 where the device is an active matrix display.

8. The flat panel light emitting device of claim 5 where each of the first and second light emitting elements are comprised of at least three distinct light emitting regions, wherein one region emits red, one region emits green, and one region emits blue light.

9. The flat panel light emitting device of claim 5 where each of the first and second light emitting elements are independently addressable.

10. The flat panel light emitting device of claim 1, further comprising an additional light emitting element positioned between the first light emitting element and the substrate or between the second light emitting element and the cover, where the additional light emitting element comprises an organic light emitting layer positioned between two transparent or semitransparent electrodes.

11. The flat panel light emitting device of claim 10 where the additional light emitting element is separated from the first or second light emitting element by an electrically insulating layer.

12. The flat panel light emitting device of claim 10 where the additional light emitting element is separated from the first or second light emitting element by an electrically conductive connecting layer.

13. The flat panel light emitting device of claim 1 where the first and second light emitting elements share a common reflective electrode layer.

14. The flat panel light emitting device of claim 1 where the reflective electrode of either of the first or second light emitting elements comprises a light reflective electrically conductive metal layer.

15. The flat panel light emitting device of claim 1 where the reflective electrode of either of the first or second light emitting elements comprises a transparent electrically conductive layer and an adjacent light reflective layer.

16. The flat panel light emitting device of claim 1 where the reflective electrodes of the first and second light emitting elements each comprise a light reflective electrically conductive metal layer, and wherein the reflective electrodes are separated by an electrically insulating layer.
